(19) United States
(12) Patent Application Publication
(10) Pub. No.: US 2006/0271405 A1
(43) Pub. Date: Nov. 30, 2006

(54) Pharmaceutical care of patients and documentation system therefor

(75) Inventors: Robert J. Cipolle, Maple Grove, MN (US); Linda Strand, Maple Plain, MN (US); Peter C. Morley, Maple Plain, MN (US); Thomas A. Kellenberger, Independence, MN (US); Michael J. Frakes, Arden Hills, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Regents of the University of Minnesota

(21) Appl. No.: 11/415,820

(22) Filed: May 2, 2006

Related U.S. Application Data
(60) Provisional application No. 60/685,600, filed on May 27, 2005.

(51) Int. Cl. G06F 19/00; G06Q 40/00; G06F 7/00

(52) U.S. Cl. 705/3; 705/4; 707/101

(57) ABSTRACT

A pharmaceutical care practitioner has a n ongoing relationship with a patient in a series of encounters. The practitioner generates an assessment, including demographics of the patient, resulting in a set of indications for pharmacotherapy. The practitioner evaluates medications for appropriateness, effectiveness, safety, and compliance, and recommends or selects medications (including dosage, duration, frequency, etc.) for each indication in a care plan. The practitioner evaluates outcomes from the medications. Items from the assessment, plan, or outcomes are coded as searchable terms in a patient database employed by the practitioner for generating the care plan. The patient database may be consolidated among many different practitioners for greater statistical power. Agreements between practitioners and third-party providers may permit practitioners to override or allow actions not normally permitted by patients' plans, such as drug substitution, dosage adjustment, or choice of source. A computer-based documentation system accesses or contains databases such as patient information, medication products, legal criteria, or insurance criteria. The system may also produce documents or reports, such as care plans, assessments, claims, invoices, statistical analyses, or practice guidelines.

### CLAIM OF PRIORITY

This application claims priority to U.S. Provisional Application Ser. No. 60/685,600, filed May 27, 2005. That Provisional Application is hereby incorporated by reference in its entirety.

### INCORPORATION BY REFERENCE

The book PHARMACEUTICAL CARE PRACTICE: The Clinician's Guide, 2d Ed., by Robert J. Cipolle, et al. (2004, The McGraw-Hill Companies, Inc.) is hereby incorporated by reference as though fully set forth herein. This book was submitted with and forms a part of U.S. Provisional Application Ser. No. 60/685,600.

### TECHNICAL FIELD

The present invention concerns the pharmaceutical care of patients, and computer-based documentation systems therefor.

### BACKGROUND

Health care systems everywhere are experiencing turbulent times characterized by cost-containment pressures, conflicting financial incentives, increasing gaps in health insurance coverage with limited access to health care. The public and health care professionals are engaged in ongoing examination of health care needs, expectation, and values. At the same time, the complexity of health care technology increases daily. Health care professionals struggle to keep up with their own specialities, and find it next to impossible to keep up with other fields and treatments that may become available.

The use of medications in treating patients is an important area of health care, and suffers from the problems of cost and complexity. In addition, this area suffers from the lack of a strong organizational role in health care systems. Drugs are prescribed by primary-care, physicians, by specialist physicians, by psychiatrists, by advanced-practice nurses, and by others. Patients themselves decide to take over-the-counter medications and food supplements for specific conditions and for health maintenance and improvement. In addition, patients engage in lifestyle choices involving substances such as alcohol, tobacco, and recreational drugs.

It is difficult enough for health-care practitioners and patients to assess the effects of the medications that they themselves administer. It is harder still to track the effects of medications that others may prescribe, and their possible interactions. For example, although physicians may be aware of drugs prescribed by other physicians, they may or may not be aware of the patient's self-prescribed medications, dietary choices, and lifestyle factors that may interact with their own medications. Often, health care professionals have no effective way to track the outcomes of their drug therapies. For example, a physician may prescribe a ten-day course of an antibiotic; if the symptoms persist, then the physician will prescribe a full course of another antibiotic, until the symptoms subside. However, whether a given antibiotic is working or not usually becomes apparent within one or two days. The usual practice is this situation is slow and expensive.

Other problems arise in the use of medications—here defined broadly as prescription drugs, over-the counter remedies, food supplements, special diets, and other substances such as alcohol, tobacco, and recreational drugs. A 1990 study found that up to 20% of hospitalizations in the United States were related to drug therapy that went wrong; Hepler, et al., “Opportunities and Responsibilities in Pharmaceutical Care”, Am J Hosp Pharm Assoc, 47:533-543 (1990). Another study, Ernst, et al., Drug-Related Morbidity and Mortality: Updating the Cost-of-Illness Model,” J Am Pharm Assoc. 41(2):192-199 (2001), found that the economic cost of morbidity and mortality related to inappropriate drugs in the U.S. was $177 billion. Eliminating all of this cost would allow the distribution of prescription drug products free of charge. Even without the human cost, this is a staggering statistic. We estimate that 50% of inappropriate drug use is preventable.

Although those in the health care arena have been slow to recognize the magnitude and scope of the problems associated with medications, attempts have been made to guide drug therapy in a positive direction. For example, politicians have employed legislative controls related to legislating the information that patients receive form pharmacists, and limiting the non-medical usage of drugs. The pharmaceutical industry has traditionally promoted drug products directly to physicians, and more recently has advertised directly to patients. The drug industry and managed care organizations currently employ disease management concepts to control types and amounts of drugs to manage the value of products relative to other entities that treat the same disease. Managed care facilities have converted this concept to a cost-accounting system for understanding alternative treatment programs for a particular disease; however, patients seldom have a single disease, so that this method does not treat the patient as a whole person.

Hospitals and other organizations have attempted to manage the cost and usage of drug therapy through pharmacy and therapeutics committees. The most commonly used system involves a formulary of drug products available for use in that institution, based upon therapeutic characteristics. The pharmaceutical industry and its pricing structure have had so much influence on the decision processes of these groups that the formulary is now considered to represent costs more than drug-use considerations. More recently, decision-making bodies have focused on developing protocols for the use of drug therapies by health care professionals. The protocols are based upon “best practices” standards available in the literature or assemble by a group of practitioners, and are meant to represent evidence-based guidelines for making decisions where drug therapy is indicated. These protocols are not standardized over different organizations, and have difficulty in dealing with patient-specific variations. In addition, few physicians are trained in pharmacotherapy decision-making rules, and many feel that they interfere with their own decision-making processes. Some pharmacists in management positions have implemented drug use evaluations and reviews to influence usage within their own organizations. Such evaluations are usually retrospective, in response to the occurrence of a particular problem. Although they provide a framework for critical evaluation, they lack timeliness and have limited impact. Some hospitals have instituted specialty clinics and clinical services devoted to subjects such as blood-thinner dosing, diabetes education, and total parenteral nutrition. After thirty years, only a small percentage of patients receive even limited assistance from these efforts, almost all of them in hospital settings.

Traditionally, physicians have been considered to hold the primary responsibility for patients' drug therapy. However, the evolution of many types of health care systems, and the wide diversity of patients' lifestyles make it difficult for any single physician to satisfy this increasingly complex responsibility. Economic considerations force physicians into allocating less time for patient visits. Multiple physicians may treat a single patient, so that any one of them has less than a total picture of the patient. Of particular importance is the dizzying increase in new drugs, knowledge of older medications (in the broad sense of this word noted above), and research into the effects of individual variations among individual patients to various medications.

### SUMMARY

Pharmacists are educated for six years in medicinal chemistry, pharmaceutics, therapeutics, pathophysiology, clinical pharmacology, and related fields. In addition, the community-based locations of many pharmacists gives open access to patients. However, giving pharmacists an active, positive role in managing patients' drug therapy requires significant changes in their typical roles. Most importantly, at least some pharmacists must assume a professional role as “pharmacy practitioners.” That is, pharmacy is being recast into a health care profession, with revisioned purpose and collective responsibility, replacing the present fragmentation and lack of cohesiveness.

In 1975, Mikeal et al., “Quality of Pharmaceutical Care in Hospitals,” Am J Hosp Pharm, 32:567-574 proposed the concept of “pharmaceutical care” as patient care to assure safe and rational drug usage. Later authors, including one of us, have elaborated this concept to define pharmaceutical care as the component of pharmacy practice that entails the direct interaction of the pharmacist with the patient for the purpose of caring for the patient's drug-related needs, and for providing drug therapy in a responsible manner for achieving definite outcomes that improve a patient's quality of life.

Although pharmacists generally accepted this vision as early as 1990, the first effort to develop a practice around it was a three-year project that we developed in 1992 to critically examine practical implications of the emerging theory of pharmaceutical care. The Minnesota Pharmaceutical Care Project, described in chapter 6 (pages 205-236) of the first edition of Cipolle, et al., PHARMACEUTICAL CARE PRACTICE, McGraw-Hill (1998), was an experiment involving 20 pharmacies and 54 pharmacists, with the collaboration of academics, regulators, pharmaceutical companies, and health-care organizations. A preliminary practice system processed 9,000 patients in 25,000 encounters, with favorable results.

Since that time, we have expanded and refined methods of pharmaceutical care practice, and have developed enhanced documentation systems for integrating these methods into health care networks. The emphasis throughout is on patient-centric approaches that consider the patient as a unique person having a certain lifestyle and preferences, and that integrates all medical conditions and all drug therapies being used to treat or prevent these conditions of the patient.

### DRAWING

FIG. 1 is a high-level flow diagram of a method according to an embodiment of the invention.

FIG. 2, comprising FIGS. 2A-2C, shows an example of an assessment form for a patient encounter.

FIG. 3 illustrates problem determination.

FIG. 4 is a flow diagram for evaluating medications.

FIG. 5 is a flow chart for a multiple-practice method.

FIG. 6 is a block diagram of a documentation system.

### DESCRIPTION

A pharmaceutical care practitioner, hereinafter referred to as a “practitioner,” is a pharmacist who has specialized higher education in patient care, and who interacts with patients individually in multiple one-on-one encounters over a period of time as a primary health care professional. Practitioner education may involve specialized courses in a college of pharmacy, or education beyond a degree which would qualify the graduate as a patient-care provider. The patient encounters involve assessing the patient's medication needs, developing a care plan for medication therapy, and evaluating outcomes of the care plan. Again, the terms “drug” and “medication” encompasses all substances that affect the patient's physical condition, including prescription drugs, over-the-counter remedies, diets, food supplements, and recreational substances. This term also subsumes specific dosages and delivery routes of the substance.

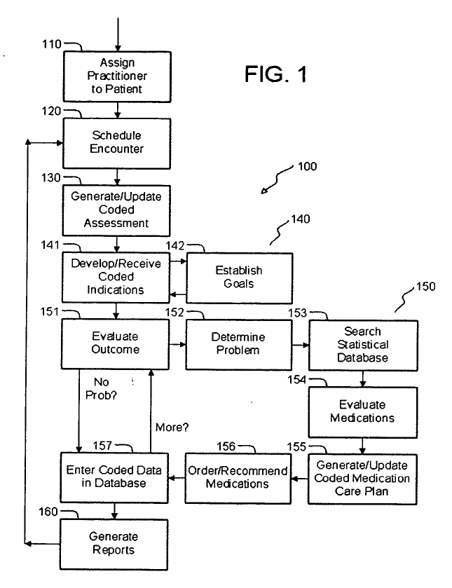

FIG. 1 is a high-level flow diagram illustrating an example method 100 showing how a practitioner may interact with a patient, who may be referred to as a subject patient to differentiate other patients. Some of the actions in a block, or all of the actions of some blocks, may be performed by the practitioner or the patient. Other actions may be performed on a suitably programmed digital data processor that receives its instructions from a memory or other medium.

In block 110, a practitioner is assigned to a patient for a course of treatment. (The terms “treatment” and “treat” herein include prevention of conditions that may arise in the future, as well as palliative care and similar services.) In block 120, an organization schedules a one-on-one encounter between the practitioner and the patient. Encounters involve a single patient, but may be conducted in person at a private office or over the telephone or similar instrumentality. The encounter involves interactivity between the practitioner and the patient, although parts of it may involve filling out questionnaires or other appropriate activities by the patient or by the practitioner alone. Encounters are ongoing; their frequency may vary with particular patient conditions or severity. For example, a diabetic patient may wish to continue for an indeterminate time with encounters a few weeks or months apart, and additional encounters if problems occur or new treatment methods appear. On the other hand, treatment of an infection with a course of antibiotics may require only two encounters. A physician may prescribe a 10-day course of antibiotics, with a return visit if the medication was ineffective after that time. However, it is generally evident after one or two days whether the antibiotic is having an effect. Therefore, a pharmaceutical care practitioner, may conduct an initial encounter when the antibiotic is started, and schedule a follow-up contact by telephone, e-mail, etc. with the patient after two days. This procedure may save considerable time, effort, and expense in finding an effective antibiotic therapy. Operations 110 and 120 may be performed by an organization such as a practice comprising one or more practitioners, a clinic having one or more practitioners on staff, or a hospital having staff, consulting, or contract practitioners.

The remainder of method 100 occurs in connection with one encounter. In block 130, the practitioner generates an assessment for the patient for a first encounter, or updates the assessment for subsequent encounters.

An assessment is a systematic review and appraisal of the patient's drug-related needs. Its purpose is to assure that all of the patient's drug therapy is appropriately medically indicated, is the most effective available, is the safest possible for that patient, and that the patient is able and willing to comply with a pharmacotherapeutic regimen. The assessment includes decision-making processes for a pharmacotherapy workup, and identifies current and prospective drug therapy problems.

Many health-care providers take patient histories. The assessment for pharmaceutical care includes history items, but is more comprehensive. It includes the patient's description of the medication experience, the medication history, and the current medication record. Because the individual characteristics of each patient create the context of the practitioner's activities, complete demographic information is important. In particular, the patient's living situation may be relevant to factors such as determining delivery routes, child-proof packaging, and exposure to second-hand smoke.

Early in the process, the practitioner encourages the patient to describe experiences relating to items such as general attitudes toward taking medication, wants and expectations from drug therapy, concerns about the therapy, degree of understanding of his or her medications, medication taking behavior, and any cultural, religious, or ethical issues that might influence the patient's willingness to take medications. These preferences impact whether and how the patient will actually take medications in the therapy. For example, a patient may desire not to have to take so many pills every day; the practitioner may then attempt to reduce the number or frequency of doses. Persons who employ herbal remedies may have a less positive attitude concerning the safety of prescription drugs, so that the practitioner may design a care plan to help the patient evaluate the effectiveness of his herbal remedies.

A comprehensive medication history of medications used in the past to treat or prevent certain conditions may elicit information that is valuable in making current therapy decisions. (The term “medication” or “drug” herein includes not only the name of the product or substance, but also its dosage, frequency, duration, delivery route, and other parameters relating to how it is used.) The purposes of the history include identifying drug-related needs (e.g., an immunization is needed), to identifying drug-related problems (e.g., an allergy to penicillin), and selecting medications for future effectiveness (e.g., hydrochlorothiazide did not work in the past). Compliance with current and past medications may also be elicited. An accurate history of social drug use is important in this context, including tobacco, caffeine, alcohol, and recreational drugs of abuse. Taking extra time to evoke information concerning previous medications—including reasons, specific products, dosage regimens, start/stop dates, and responses—may save the patient inconvenience and suffering in the future. It is also important to obtain, not only past drug treatments that were effective, but also past drug treatments that failed, that produced undesirable effects, or that the patient did not follow for some reason.

An electronic therapeutic record covers all of the patient's current medical conditions and illnesses, and how well they are currently being managed by drug therapy. It includes for each drug the indication for use, the product name, the dosage regimen, the duration of therapy, and the clinical results to date. As well as physician-diagnosed diseases, indications may include preventive steps, relief of uncomfortable symptoms, correction of abnormal laboratory test results, reduction of risk factors, and other reasons.

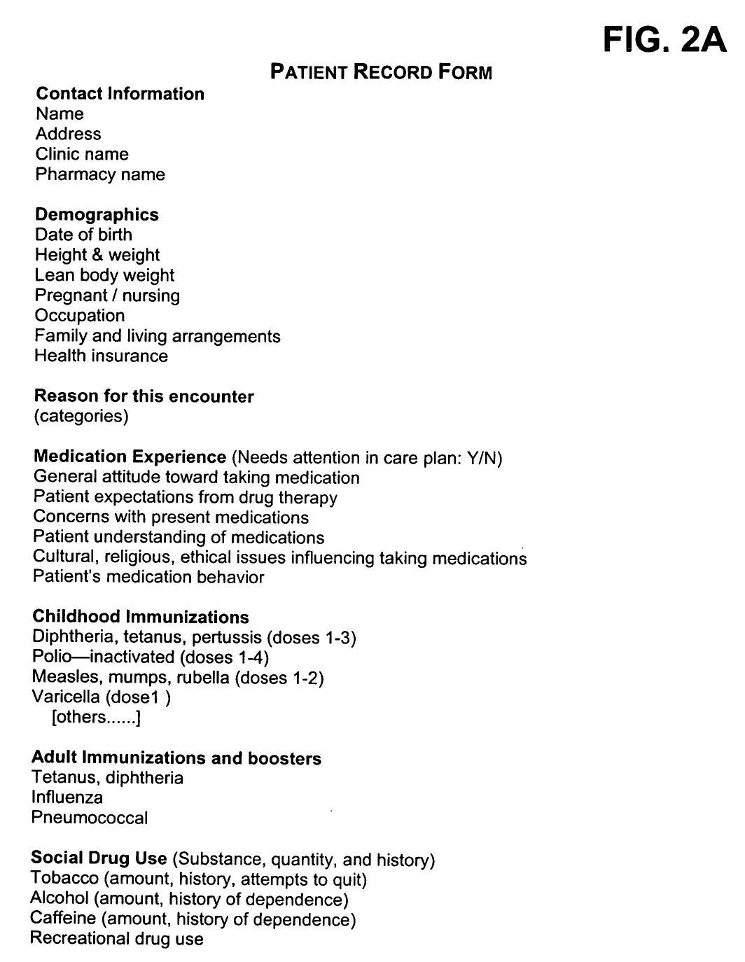

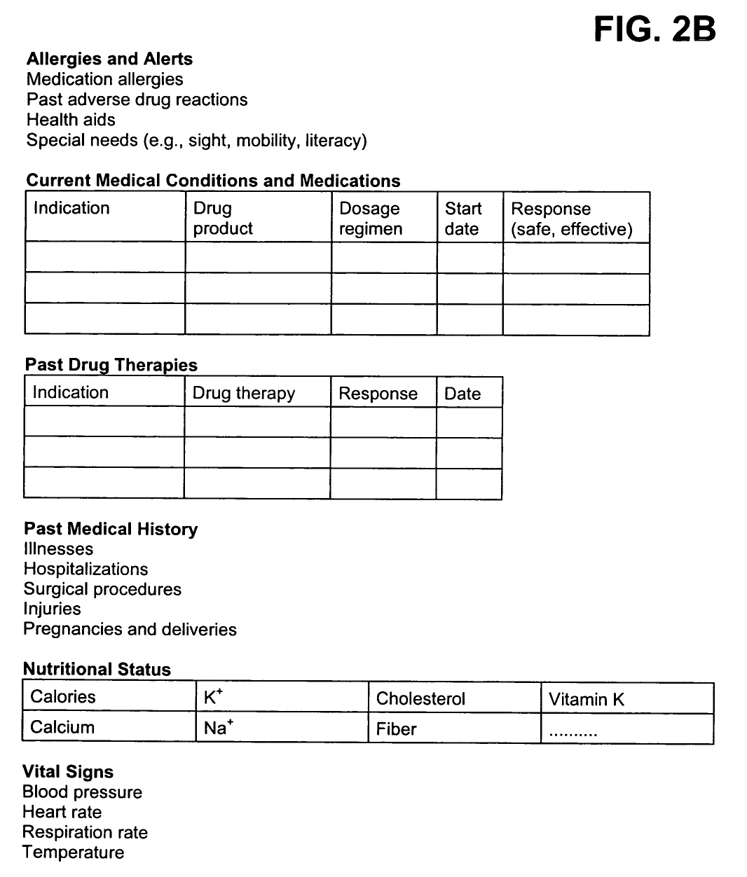

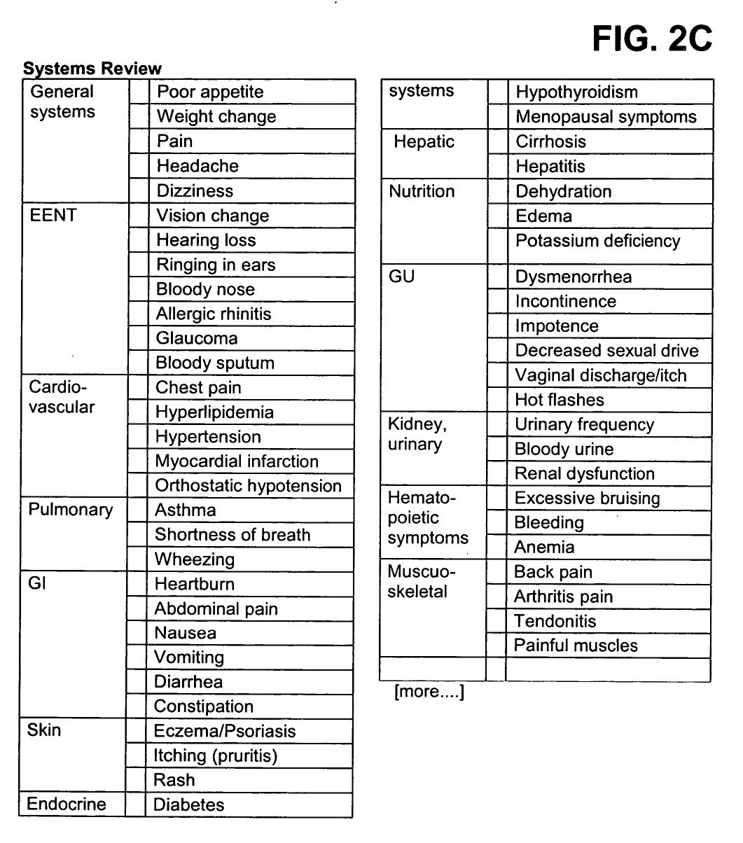

FIG. 2, comprising FIGS. 2A-2C, shows a portion of a representative form from which an electronic therapeutic record form can be derived, suitable for use as a guide during an assessment encounter with a patient. The form includes the topics mentioned above, and others as may be desired to develop a thorough medical history, statistical demographic information, past medications and their outcomes, and other information. The form may be completed or updated during an encounter, or parts of it may be completed by the patient before an encounter. Data from the form may be directly input into a computer, or a person may transcribe the data in a computer later. In either event, the data in the form are not merely transcribed, but are coded in a manner that the individual items may be entered into a database involving multiple patients. For example, clinical results, also termed responses or outcomes, as discussed in more detail below. The outcome categories serve two purposes: measuring progress in achieving pharmacotherapy goals, and determining whether an intervention is required.

Information from the form in FIG. 2 may be classified into several notional groups. For example, the following list illustrates some of the items that may be coded by the practitioner or by someone else for entry as searchable items in the database. Items that are not inherently quantitative, such as “expectations” below, may be assigned category codes in the same manner as for outcomes, above.

TABLE I

| (1) | Patient demographics | |
|---|---|---|
| | (a) | Identifiers |
| | | Name |
| | | Record number |
| | | Age, gender |
| | (b) | medication experience |
| | | Preference |
| | | Concerns |
| | | Expectations |
| | | Understanding |
| | | Pregnancy status |
| | | Activity level |
| | | Patient alerts* |
| | | Occupation |
| | | Marital status |
| | | Primary physician |
| | (c) | Financial |
| | | Insurance carrier |
| | | Insurance plan |
| | (d) | Medication history |
| | | Adverse reactions |
| | | Allergic reactions to drugs |
| | | Social drug use |
| | | History of effective past treatments |
| | | History of failed past treatments |
| (2) | Indication | |
| | (a) | Medical condition-separate set for each condition |
| | | ICD-9-CM** code for the condition |
| | | Goals of therapy |
| | | Interventions |
| | | Desired outcomes |
| | | Evidence-based guidelines |
| | | Best-practice guidelines |
| | | National Consensus guidelines for recommended care |
| | (b) | Documents |
| | | Laboratory test results |
| | | Assessment questions (pain scale, depression scale) |
| | | Patient survey responses |
| (3) | Drug product-separate set for each product for each indication | |
| | (a) | Identifiers |
| | | NDC*** codes by product |
| | | GPI**** codes by therapeutic category |
| | (b) | Source |
| | | Where patient obtained the drug (Rx, OTC, |
| | | friends/family, etc.) |
| | (c) | Display for patient |
| | | Generic name |
| | | Brand name |
| (4) | Drug dosage-for each drug product | |
| | | Sig(netur) direction codes |
| | | Daily dosage regimen |
| | | Administration times for each dosage administration |
| | | Time to achieve therapy goal |
| (5) | Drug therapy problems | |
| | | Category |
| | | Indication causing the problem |
| | | Effectiveness |
| | | Safety |
| | | Compliance |
| | | Causes |
| | | Resolution actions |
| | | Changes in drug product, dosage, route, etc. |
| | | Resolution contact (to resolve a problem; |
| | | e.g., patient, MD, insurance) |
| | | Physician or prescriber |
| | | Patient |
| | | Insurance carrier |
| (6) | Outcomes-for each indication | |
| | (a) | Clinical |
| | | Outcome status from standardized list |
| | (b) | Economic |
| | | Health-care savings amount |
| | | Hospitalizations, ER visits, etc. avoided |
| | | Costs for needed prevention |
| | | Initiating preventive medications or vaccines |
| | | Specialist referrals |
| | (c) | Humanistic |
| | | Patient satisfaction surveys |
| | | Quality of life improvements |

*Patient alerts are personal characteristics of the patient that the practitioner should be aware of, for example, that the patient has limited mobility, or needs an interpreter.
**International Classification of Diseases, Ver. 9, Clinical Modification (1979). Available from World Health Organization.
***National Drug Code. Available from US Food and Drug Administration
****Generic Product Index is a standardized file of parameters that enables replacement of any drug with another drug that is therapeutically equivalent.

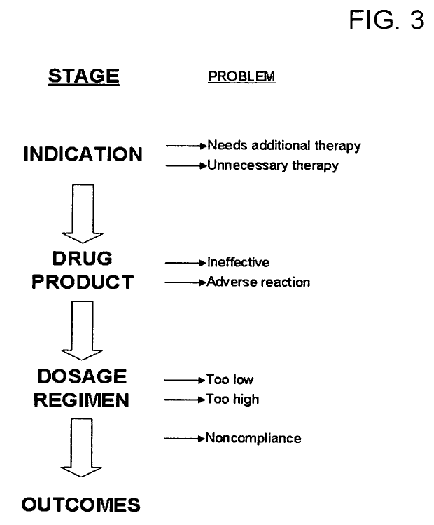

As an example of enhanced coding that replaces previous text records, the “Sig” item (4) of Table I employs a purpose-built standardized command language where each entry begins with a verb, such as “take” or inject,” then adds parameters for drug quantity, dosage type, delivery route, frequency, duration, and other. Each parameter value has a standard definition with a unique code, so that entries in a database may be searched by any parameter value, and so that other practitioners and other medical providers are aware of exactly what was prescribed for or recommended to the patient. As another example, the “category” in item (5) is coded as one of the seven problem categories in FIG. 3, rather than as a text entry. Each category has a standardized definition.

Returning to FIG. 1, blocks 140 are iterated for each condition that may require medication therapy for the patient.

Block 141 generates a list of coded indications from the data provided by the patient, and by observing the patient. An indication is a sign or symptom that suggests the necessity or advisability to initiate pharmacotherapy, or a reason for the use of a drug therapy for the treatment, prevention, or diagnosis of a patient condition. A condition is an illness or symptom of the patient. The indications may be developed first from the patient and second from other care givers, perhaps via physicians' reports, results of laboratory tests, and so forth. If necessary, received indications may be coded or recoded into the categories of the practitioner's database, so that they may be searched at a later time. On subsequent encounters, indications are updated from previous encounters.

Block 141 may also receive and access the patient alerts noted in Table I. A practitioner or other provider or entity may wish to gather certain information, for statistical or other purposes, from only those patients having certain demographics, or over a certain period of time, for example. To this end, a patient alert or trigger may be inserted, so that when specified variables have selected values, block 141 initiates a task to request the information.

Block 142 establishes a goal for medication therapy for each condition elicited in block 141. The goal may be arrived at by discussion between the practitioner and the patient. The practitioner may inform the patient as to what results may reasonably be expected from drug therapy. The goals of pharmacotherapy may be individualized and include which parameters are to be evaluated, the desired parameter values, and the time expected to achieve the desired values. Established goals may be modified as well.

Operations 150 are performed for each indication of block 140.

Block 151 evaluates an outcome for a current indication.

An outcome represents the actual results of an intervention with drug therapy. It may have a number of characteristics, such as physiological (signs, symptoms, etc.) and clinical (laboratory test values). It may also have other dimensions, such as economic (health care costs or savings) and behavioral (patient satisfaction). An outcome is described by placing it in one of a number of standard coded categories, such as “resolved,” “stable,” “improved,” “partially improved,” unimproved,” worsened,” “failed,” or “expired.” Each category may have an agreed definition across many practices. For example, the difference between “improved” and “partially improved” may be defined as:
Improved: adequate progress is being made toward achieving the goals of therapy at this point in time. The same drug therapy will be continued.
Partially improved: Some measurable progress is being made toward achieving the desired goals of therapy, but adjustments in drug therapy may be required. Usually dosage changes or the addition of additive or synergistic therapies is required.
   For certain conditions and outcomes, such as “improved” or “stable,” the current therapy needs no adjustments, because no drug-therapy problems exist that need to be addressed. In that event, method 100 proceeds directly to block 157. For an initial encounter or for a new indication where no previous status has been developed, an “initial” outcome may have categories such as “refer” and “treat.” For the former, the patient may be referred to another health-care professional. For the latter, the practitioner may recommend treatment, or may prescribe a medication under a collaborative practice agreement with another medical provider who is licensed to prescribe the drug.

Some outcome categories bespeak the existence of a drug-therapy problem with the current therapy. A drug therapy problem is an undesirable event experienced by a patient which involves, or is suspected to involve, drug therapy, and that interferes with achieving the desired goals of therapy. Block 152 assesses any problems with the drug therapy for that indication or condition. Problems may occur at any stage of the patient's medication use, as shown in FIG. 3. At the indication stage, the patient may need additional therapy for that indication. On the other hand, medication may be unnecessary; for example, if a medical condition is resolved, then medication is no longer required, and may be discontinued for that indication. At the product stage, a currently used drug may be ineffective in treating the indication, or may cause an adverse reaction, either by itself or in combination with another medication. At the regimen stage, a dosage may be too high or too low. Patient noncompliance with a therapy may cause a problem. In Cipolle, et al., PHARMACEUTICAL CARE PRACTICE, 2d Ed., above, Table 2-20 on page 50 lists the leading medical conditions involved in each of these types of drug-therapy problems.

In solving a problem, the practitioner may search, at 153, a statistical database which contains medications along with indications for their use, pertinent regulations, formulary listings, and so forth, by entering pertinent data, keys, or queries for the subject patient. The database is statistical in that it consolidates information concerning accumulated use experiences and outcomes experienced by other patients, in the same practice or in other practices. The statistical information further includes demographic and other information gathered during patient encounters and perhaps from other sources as well, such as medical studies. Results of the search produce candidate medications (including dosages, durations, etc.) that the practitioner may consider for the patient. A practitioner may thus be able to determine not only that a particular drug is indicated for a particular condition, but also that, say, the drug seems to be less effective in elderly patients than for younger adults, or that use produces toxicity in some demographic groups of patients.

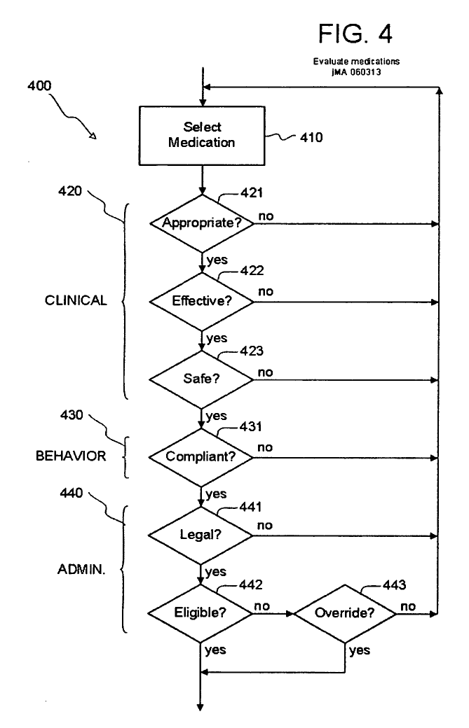

Block 154 evaluates a candidate medication product. FIG. 4 illustrates a method 400 for an evaluation. After block 410 selects a product, blocks 420 test it for medical considerations. Block 421 determines whether the medication is appropriate. Block 421 may find that there is no medical indication for the drug, or that the drug duplicates the effect of another product, or that a non-drug therapy is more appropriate. The test may determine that the purpose of the product is to treat an avoidable adverse reaction to another medication. If the drug product is not appropriate, block 410 selects another candidate.

Medical test 422 determines whether or not the drug is effective. A medication may be ineffective if a different product is required. For example, a more effective product may be available, or the medical condition may be refractory to the drug. The form or delivery route of the drug may be faulty. The dosage may be wrong or the frequency or duration incorrect. The product may cause an interaction that reduces the effectiveness of that or of another drug.

Medical test 423 measures safety factors. A medication may be unsafe if it causes an adverse reaction, such as an undesirable effect for all persons or for one having the demographics of the subject patient, or a drug interaction, or problems from a dosage that is initiated or changed too rapidly, or an allergic reaction, or if a contraindication is present. (A contraindication may arise from a changed condition in the patient; e.g., she becomes pregnant, and should discontinue a previously safe drug.) A drug may also be unsafe if the dosage is too high (e.g., toxic reaction), or because of a wrong dose, or an incorrect frequency or duration, or a faulty administration, or a drug interaction at the prescribed dosage. (A drug interaction may cause either a safety or an effectiveness failure: the former if the interaction has an unsafe reaction in the patient, the latter if the interaction reduces the effectiveness of a drug in the care plan.)

Behavioral factors may be tested at 430. Block 431 shows a test for patient compliance. In medical circles, “compliance” has a negative connotation, that the patient unreasonably refuses to take a prescribed medication. However, test 431 considers may other factors as well. For example, the patient may not understand the directions or be illiterate. The patient may prefer not to take certain medications, perhaps for cultural or religious reasons. The patient may forget to take the drug, perhaps because of memory deficits or dementia. The selected product may be too expensive for the patient to afford, or may be unavailable to the patient. The patient may be unable to swallow or inject the drug, possibly because of a lifestyle situation such as living alone. Blocks 440 relate to administrative factors. Block 441 tests the drug against legal criteria, such as applicable Federal, state, and other regulations, to determine whether the proposed drug or dosage meets them.

Block 442 determines whether the medication, dosage, and delivery system meet any applicable criteria as to third-party payment, such as insurance. For example an insurer may have a formulary listing products for which it will contribute to part or all of the cost. Some providers also may grant waivers, perhaps at a higher copayment. If the selected product is not eligible, block 443 may permit an override by the practitioner. Agreements between third-party payers and pharmaceutical care practitioner may permit the practitioner to override an eligibility requirement in certain situations: for particular products, for particular patients or classes of patients, or in other cases. The override may be performed with or without prior request from the third party, and with or without subsequent notification of the third party. Agreements may permit overrides as to medication products, as to number and timing of refills, as to substitution of brand-name for generic products (including dosage, frequency, etc.), as to where a medication may be obtained, or as to other factors as well.

The first four tests are preferably performed in order. That is, if a drug is not appropriate to the indication, then whether it is effective or not is of no concern. If it is not effective, then safety does not matter. If it is unsafe, then expected compliance is not an issue. If any of the tests fails, another medication is selected. If the medication product passes all tests, then method 400 is satisfied.

Returning to FIG. 1, block 155 generates a coded medication care plan from the medication(s) evaluated in block 154. A care plan in this context is a detailed schedule specifying the practitioner's and the patient's activities and responsibilities. It is designed to achieve the therapy goals set in block 142, and to resolve and prevent drug therapy problems. The care plan is a document that may be organized according to medical condition or indication for drug therapy. It may include the following items:
A statement of the goals of therapy;
Interventions by the practitioner and actions to be taken by the patient to achieve the goals of therapy, to resolve any present drug therapy problems, and to prevent future drug therapy problems; or
A schedule for a follow-up encounter, if indicated.
   Care plans may be documented separately by medical condition or illness; for example, a patient having two chronic conditions and one acute illness with five total medications has three sections. The care plan document lists each medical indication and includes a brief summary of its signs or symptoms. Goals of therapy are a prominent part of the care plan. One of the valuable additions that a pharmaceutical care practitioner makes to the patient's health records is explicitly stated goals of therapy. A care plan includes dosage instructions for each drug product, including dose amount, delivery route, frequency, time of day, and duration. Other interventions in support of the specific pharmacotherapy may also be recorded in the plan. These may include health advice, exercise, dietary changes, or instructions on the proper use of medication administration or monitoring devices. A plan may further include a schedule for subsequent follow-up evaluations, including effectiveness and safety parameters. The patient must clearly understand from the plan which interventions are the responsibility of the practitioner and which are the patient's responsibility. The patient should also understand what improvements in signs or symptoms and what changes in laboratory test results may be expected from the drug therapy, and their use to evaluate effectiveness and safety in a follow-up encounter.

As noted in Table I above, items in the care plan are coded—rather than merely being entered as text fields—so that the plan may be entered into and searched from a database.

Block 156 acquires medications in the care plan. For prescription drugs, the practitioner may send a recommendation to an appropriate health-care provider, or may himself write a prescription under a collaborative practice agreement. Non-prescription products may be listed for the patient to obtain.

Within block 156, the practitioner may normally send prescriptions to local pharmacies for fulfillment, but may order medications for chronic or other appropriate conditions from a mail-order or similar pharmacy, if this would reduce costs. The practitioner may make this determination, or may operate under an agreement with health-care providers or third-party reimbursement organizations such as insurance companies. Terms of the agreement may permit the practitioner to select a source for the medication with or without prior approval, or subsequent notification. The agreement may allow reimbursement if the practitioner selects a source not normally covered under the patient's plan.

Block 157 enters coded data from previous blocks into a practice database. Although data may be coded when entered—say at a window on a computer screen—or transcribed from a paper document, it is at some point entered in a form that is searchable from other places in method 100 or in other methods. If the patient outcome is “expired,” block 157 may receive data concerning factors that may have contributed to death, especially if they are drug-related. At this stage of the method, the database is normally maintained on a practice level; that is; as one or more pharmaceutical practitioners operating as a group. Data received in response to patient alerts or triggers may also be entered here. If there are more indications to process, method 100 returns to block 151. Otherwise, the method passes to block 160.

Block 160 generates reports from information produced in the encounter. Besides the care plan to be given to the patient, block 160 may develop a medical summary listing current medications along with other information such as who prescribed them and when, and for what condition. This report may be given to the patient, sent to other health-care providers who interact with the patient, or sent to third-party providers. Block 160 may generate billing reports and invoices for the practitioner's services, portable medical summaries for the patient, medication therapy management (MTM) summaries for other care providers, a medical diary listing what the patient took and when, or may also generate a calendar of future appointments. Prescriptions from block 156 may also be printed or sent electronically in this block.

Method 100 then returns to block 120. For follow-up encounters, block 120 may use a schedule generated in block 155.

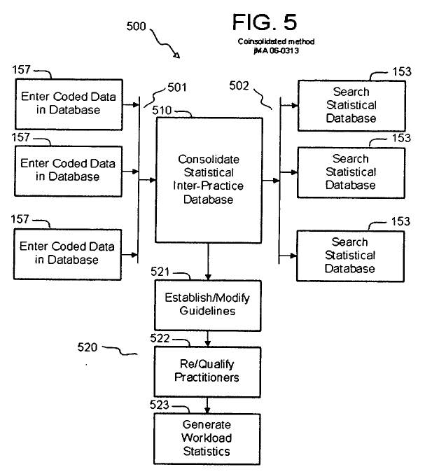

FIG. 5 shows a multiple-practice method 500, for enhancing the power of the statistical database employed in connection with method 100. The purpose of a statistical database in the present context is to acquire statistical information concerning experiences of patients of differing demographics with respect to a range of products (both prescription and non-prescription, including different dosages, durations, or delivery routes), that may be useful in treating future patients. Thus, the database should contain a large number of entries for differing patient demographics, drug products, etc. A “large number” signifies a number great enough to impart statistical or clinical meaningfulness to the database for many of the searches that are likely to be entered into it. Clinical meaningfulness may sometimes be imparted by a smaller total than that required for statistical meaningfulness. For example, half a dozed severe adverse reactions to a drug out of ten thousand prescriptions for the drug may be clinical significant even though it has little statistical weight. While each practice of one or more pharmaceutical care practitioners in a single practice may over a period of time accumulate enough patients having different demographics and conditions to yield statistically valid guides, combining the databases of multiple practices offers orders of magnitude more opportunities for a larger number of conditions and treatments.

In the present context, a “practice” is an economically independent unit or geographically isolated unit. As noted above, a single practice may comprise one or more pharmaceutical care practitioners doing business separately from other medical functions. A practice may alternatively comprise a pharmaceutical care practitioner or department of a pharmacy, clinic, hospital, or similar organization. In some cases, a single economic entity such as a regional or national chain of multiple pharmacies, retail outlets, etc. may be sufficiently large to establish a valid statistical database for a large number of patients.

Blocks 157 in method 500 represent entry of data into individual practice databases in connection with patient encounters. Lines 501 represent the communication of the individual practice data to block 510, where is consolidated into a single multiple-practice database. The multiple-practice database may accumulate data from practices in a city, a region, a state, or even international practices. The schema of the larger database may be communicated to individual practices or published in a standards document. The individual databases may store data in the same schema, or may translate the data upon communication to the larger database. Translation may permit the individual practices to maintain additional data, such as billing information, that is not relevant to the purposes of the larger entity. It may also permit data to be kept in a format that is more appropriate to the needs of the individual practice. Alternatively, individual practices may enter their data directly into the inter-practice database.

Multiple blocks 153 signify that, when a method 100 of an individual practice accesses the statistical database in block 153, that block accesses the multiple-practice database instead of—or in addition to—its individual practice database. Lines 502 thus represent queries communicated to the consolidated database, and results therefrom that are communicated back to blocks 153 of the requesting practice.

Method 500 may perform further functions 520 as well. For example, block 521 may establish or modify guidelines for recommended pharmaceutical care. National consensus guidelines now exist in some areas, and more may be developed in the future; these can be incorporated easily. Block 522 may monitor the performance of individual practitioners for educational purposes or to qualify or requalify individual practitioners. Statistical norms from the database may be applied to individual practitioners for these and other purposes. Block 523 may generate workload statistics from communicated individual practice data detailing numbers of patients seen, duration or frequency of encounters, etc. An algorithm may analyze encounters for a complexity measure—rather than merely time spent or numbers of patients seen—in order to assign workloads more fairly, and to bill for resources consumed more equitably. (Cipolle, et al., PHARMACEUTICAL CARE PRACTICE, 2d Ed., above, discusses such a measure at pages 347-355.) Although such data are useful within a single practice, and may be kept in the individual database, it becomes more useful when consolidated and analyzed over a number of practices, for use in estimating personnel requirements and other factors. These data may be accessible from each practice.

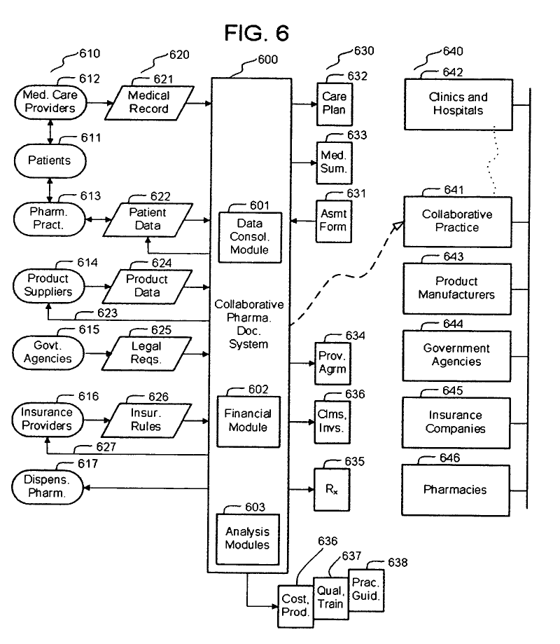

FIG. 6 describes a computer-based documentation system 600 for pharmaceutical care. Such a system may reside within a single pharmaceutical care practice, or in multiple practices; or certain modules may be shared among multiple practices, or with other health-care providers such as hospitals. In this description, system 600 is called a collaborative care system, because it involves persons other than only the pharmaceutical care practitioner and the patient. The first column in FIG. 6 lists personnel or organizations 610 who participate in pharmaceutical care by providing inputs to or receiving outputs from system 600 in the third column. The second column lists databases 620 used and produced by system 600. The fourth column includes some specific documents 630 used and produced by the program. The fifth column indicates a number of computer hardware complexes 640 that may link to the system for providing and receiving data; these complexes include one or more sets of digital processors for executing programs, devices for inputting and outputting data, internal and external memory for holding data and instructions, and communications devices for transferring data to each other and to other hardware complexes. The blocks shown in the columns of FIG. 6 are examples. Other persons, databases, documents, and computer systems may employed as well. In general, the databases, documents, and hardware may be added, and some of them may be omitted if desired. In general, the databases, documents, and hardware may be associated with the participants that are horizontally aligned with them in the diagram. The system software runs on the collaborative practice hardware 641, as indicated by the dashed arrow. In some environments, this complex may be physically the same as one of the clinical/hospital hardware 642, as indicated by the dotted line. Medium 699 represents a physical stored or communicated form of the instructions and data for programming one or more processors such as 6411 to carry out the functions of system 600.

Normally, a patient 611 may first interact with a medical care provider 612 such as an MD, DO, nurse practitioner, physician's assistant, chiropractor, or advanced-practice nurse who may prescribe or suggest a medication for treatment of a specific condition in the patient. All or part of a medical record 621 generated by the medical care provider, but including at least the medication, may be input into a module of system 600, either automatically or manually, such as by a conventional paper prescription.

A pharmaceutical care practitioner 613 (again, references to “practitioner” are to this person, unless otherwise stated) may then interact with the patient, as shown in the first column of the diagram. This interaction corresponds to an encounter described in connection with FIG. 1. In some settings, the practitioner may have an area within a pharmacy, or an office in a clinic or hospital. The practitioner generates an assessment by filling out an assessment form 631, such as the partial example shown in FIGS. 2A-2C. The form may request data concerning all medical conditions being treated, known allergies and intolerances, other prescriptions, non-prescription remedies, food supplements, substances such as alcohol and tobacco, results of laboratory tests, and demographic information. Both current and past information may be solicited. Demographic information is also included. Patient preferences and compliance with medications may be included. System 600 may produce (or receive) codes that represent assessment items in a form that can be searched as entries in a patient database 622. A system module codes data from the assessment into a searchable form acceptable to module 601.

Data consolidation module 601 in system 600 may add the records in this assessment to form a consolidated patient database 622. As described earlier, patient databases may exist as separate modules in a system 600 for separate practices, perhaps accessible by systems 600 in other practices; or it may be stored in a server in hardware 640 that is common to or searchable by a number of practices in an area. Practitioners 613 may search this database from module 601 with keys or other search arguments to match a subject patient with other patients who have similar conditions, medications, demographics, and so forth, as described for block 153, FIG. 1. The consolidation of many patient records or assessments into database 622 allows the practitioner to examine a much wider range of patient factors than the usual medical care practitioner 612 does. Data concerning patient compliance with current and past medication regimes may guide the practitioner 613 in determining what future regimes are likely to be followed or not followed by the patient.

The practitioner may input coded indications and outcomes from blocks 141 and 151, and develop a coded personal care plan 632 as described in connection with block 155, FIG. 1, using data from consolidated patient database 622. This plan may be given to the patient and perhaps sent to medical care personnel 611 as well. The system may further generate documents such as a portable medication summary listing all medications and their purposes. The summary may be ordered by indication, and may contain additional directions beyond those that an MD would give, such as such as specific times of day or sequences for taking certain drugs Although some conventional electronic medical records systems produce viewable lists of current prescription medications for the use of medical personnel, system 600 generates it in summary form that can be given to the patient, and may include non-prescription medications. This document may contain other information as well, such as allergies and intolerances.

Practitioner 613 may schedule further encounters or less formal communications with the patient to determine whether newly prescribed and other medications are successful (i.e., have a desired clinical outcome) in treating identified conditions, both temporary and chronic.

Information from follow-up visits or calls may also be added to the patient's electronic therapeutic record. Treatment effectiveness, reported side effects, and ongoing patient compliance may be entered into the assessment. These data also may be consolidated into patient database 622 for consideration with regard to other patients. For example, a pattern of patient non-compliance with a certain drug program may lead to changes in dosage, delivery route, packaging, or instructions. In view of current interest in post-marketing surveillance of possible drug side effects, efficacies, or dosing after approval by the U.S. Food and Drug Administration (FDA) or other governmental bodies, data from database 622 may be sent back for further consideration, as shown by arrow 623 from system 600 to product suppliers 614. Data received in response to patient alerts may be sent to the person or organization that initiated the alert, which may include medical providers, insurance carriers, drug manufacturers, or others.

Suppliers 614 of drug products may provide product data 624 concerning recommended dosages, indications, contraindications, interactions, side effects, and other aspects of their medications. Again, such data may include medications other than prescription drugs. Product data may be input into system 600 manually or on-line, from the suppliers directly or via published compendia. Alternatively, system 600 may be provided with links to access such information on servers 643 operated by the suppliers. The product database assembles the product data and a system module makes it available to the practitioner from system 600.

Various governmental agencies and legislatures 615 promulgate rules concerning allowable dosages and uses of certain medications. System 600 may collect these rules or make them accessible from servers such as 644 in a database 625 searchable from a system module by the practitioner.

Insurances providers and other third parties 616 commonly include criteria or rules concerning aspects of medications—such as formularies of approved drugs—life of prescriptions, and refill amounts and schedules in a patient plan. Documentation system 600 also collects—or has facilities to access—these criteria or terms of agreements with multiple providers, possibly from provider servers 645, in a database 626. Database 626 may include data identifying which patients are subject to which provider, and to which rules for that provider. As described in connection with block 443, FIG. 4, the practitioner may request a modifications or waivers of such rules from the providers; or, under agreements 634 with the providers, may allow the practitioner to override certain rules entirely in the professional judgment of the practitioner. Terms regarding these agreements may also be coded to be searchable via a system module from database 626. The practitioner may communicate such overrides by reporting to insurance providers manually or on-line, as indicated by arrow 627.

System 600 contemplates that dispensing pharmacists 617 who actually fill prescriptions 635 may not normally be the same persons as the pharmaceutical care practitioner 613. Therefore, practitioner 613 may generate prescriptions and send them externally to dispensing pharmacists 617 at other physical locations, either in hard-copy form or electronically by a system module to their computers 646. System 600 may also include facilities for selecting a dispensing pharmacist—possibly according third-party approved sources—or a type of pharmacy, perhaps under agreements such as 634. For example, the system may send a prescription for an ongoing medication for treating a chronic discase to a mail-order fulfillment house to decrease costs, while short-term prescriptions may be sent to a local pharmacy. Agreements may also permit the practitioner to select a source that is not approved under the patient's reimbursement plan. Terms of these source agreements may be coded and stored in a database such as 626 for retrieval by the practitioner. Recommendations for non-prescription medications may be given directly to the patient.

System 600 may include other subsidiary functions as well. For example, a financial module 602 may calculate billing for the practice, or may generate invoices or insurance claims 636. Analysis modules 603 may generate documents 636 to calculate economic savings relating to drug therapy problems at the point of service, or to compare the cost-effectiveness of various courses of treatment or of various medications. Analysis modules 603 may further produce qualification and training documents 637 for pharmaceutical care practitioners. The modules may analyze data from database 622 or other sources to generate and modify a set of practice guidelines 638 that identify recommended practices to be followed by pharmaceutical care practitioners for achieving successful clinical outcomes. Other reports and statistical analyses may be generated as well.

### CONCLUSION

The foregoing description and the drawing illustrate specific aspects and embodiments of the invention sufficiently to enable those skilled in the art to practice it. Alternative embodiments may incorporate structural, logical, electrical, process, and other changes. Examples merely typify possible variations, and are not limiting. Individual components and functions are optional unless explicitly required, and the sequence of operations may vary. Portions and features of some embodiments may be included in or substituted for those of others. One or more of items in a list may be included, in any combination. Individual activities in methods may be performed in any order, or at any times, unless explicitly indicated otherwise. The Abstract is furnished only as a guide for subject-matter searching, and is not to be used for claim interpretation. The scope of the invention encompasses the full ambit of the claims and all available equivalents.

Having described representative embodiments thereof, we claim as our invention:

1. A documentation system for pharmaceutical care practice, comprising:
a module for entering coded patient data from encounters with a pharmaceutical care practitioner into electronic therapeutic records, the patient data including demographics, past and present medications, drug therapy problems, and medical indications for pharmacotherapy, and for entering coded outcomes from pharmacotherapy;
a module for consolidating the patient data with a patient database holding statistical assessment data from a large number of patients;
a module for searching the statistical data using a key including data from at least one of the encounters associated with a subject patient;
a module for accessing a product database containing known characteristics of a set of medications;
a module for accessing a legal database containing legal criteria concerning medications;
a module for accessing an eligibility database containing eligibility criteria of at least one third-party provider;

2. The system of claim 1 further comprising a module for transmitting prescriptions directly to at least one pharmacy.

3. The system of claim 1 further comprising a care plan for the subject patient, the care plan including
at least one indication,
an expected outcome for that indication,
at least one medication associated with that indication.

4. The system of claim 1 further comprising a module for receiving medical records from health care providers.

5. The system of claim 4 where the medical records include laboratory test results.

6. The system of claim 1 further comprising a module for outputting a portable medical summary for the subject patient, the medical summary including
all current medications for the subject patient for associated ones of the indications,
instructions for taking each medication.

7. The system of claim 1 further comprising a financial module for producing claims against third-party providers for medications recommended or prescribed by the practitioner.

8. The system of claim 1 further comprising a financial module for producing invoices for medication therapy management services by the practitioner.

9. The system of claim 1 further comprising an analysis module responsive to the patient database for producing statistical analyses and reports.

10. A method, comprising:
assigning a subject patient to a pharmaceutical care practitioner in a practice;
generating or updating an electronic therapeutic record for the subject patient, including demographics, present and past medications, and drug therapy problems;
developing a set of indications exhibited by the subject patient and treatable or preventable by one or more medications;
recording one or more outcomes resulting from pharmacotherapy of each indication;
for at least some of the outcomes, searching a multiple-practice patient database for statistical information concerning candidate medications for the indications and demographics relating to the subject patient;
evaluating the medications found in the database for appropriateness, effectiveness, safety, and compliance;
entering data from the assessment and the outcomes in searchable form into the multi-practice patient database and consolidating the entered data with similar data from a large number of other patients assigned to pharmaceutical care practitioners in other practices.

11. The method of claim 10 where each of the candidate medications includes a product name and one or more of a dosage amount, a frequency, a time of day, a duration, or a delivery route.

12. The method of claim 10 where the practitioner is a registered pharmacist having specialized training in pharmaceutical care of patients.

13. The method of claim 10 where the multiple practices are economically separate organizations.

14. The method of claim 10 where the multiple practices are geographically dispersed.

15. The method of claim 10 where the medications are evaluated for appropriateness before being evaluated for effectiveness.

16. The method of claim 10 where the medications are evaluated for effectiveness before being evaluated for safety.

17. The method of claim 10 where the medications are evaluated for safety before being evaluated for compliance.

18. The method of claim 10 further including:
evaluating each medication for legal criteria;
modifying the care plan if the medication does not meet the legal criteria.

19. The method of claim 10 further including evaluating each medication for eligibility criteria of a third-party provider.

20. The method of claim 19 further including modifying the care plan if the medication does not meet the eligibility criteria.

21. The method of claim 19 further including overriding the criteria if the medication does not meet the eligibility criteria.

22. The method of claim 21 where overriding the eligibility criteria is performed in accordance with an agreement between the practitioner and the third party.

23. The method of claim 10 where modifying the care plan includes:
determining a problem relating to at least one current medication in the care plan;
modifying a medication in the care plan.

24. The method of claim 23 where modifying a medication in the care plan includes modifying a dosage or delivery route.

25. The method of claim 10 further including issuing a prescription from the practitioner to a pharmacy.

26. The method of claim 25 further comprising selecting among multiple types of pharmacy.

27. The method of claim 10 where generating the care plan includes receiving a prescription for a medication from a health-care provider.

28. The method of claim 10 where the assessment includes compliance with medications.

29. The method of claim 10 further comprising analyzing data from the multiple-practice database so as to determine qualifications or training needs of the practitioner.

30. A method, comprising:
assigning a subject patient to a pharmaceutical care practitioner; the practitioner being a registered pharmacist having specialized education in patient care;
generating an electronic therapeutic record for the patient, including demographics, present and past medications, and drug therapy problems;
developing a set of indications for patient conditions treatable or preventable by pharmacotherapy;
searching a consolidated patient database for statistical data matching certain portions of the electronic therapeutic record and the indications;
developing a medication care plan of medications for each of the indications at least partly in response to data derived from a consolidated patient database that includes demographics, indications, and outcomes associated with a large number of other patients;
evaluating outcomes from each indication in the care plan;
evaluating each medication in the care plan for appropriateness, effectiveness, safety, and compliance in terms of the drug therapy problems;
coding data in the electronic therapeutic record and the outcomes of the subject patient and of other patients as searchable items in the consolidated patient database, such that the consolidated patient database contains statistical data regarding the assessments, indications, and outcomes for a large number of patients.

31. The method of claim 30 where each medication is evaluated for appropriateness, effectiveness, safety, and compliance in the order listed.

32. The method of claim 30 further including:
evaluating each medication for legal criteria;
modifying the care plan if the medication does not meet the legal criteria.

33. The method of claim 30 further including evaluating each medication for eligibility criteria of a third-party provider.

34. The method of claim 33 further including modifying the care plan if the medication does not meet the eligibility criteria.

35. The method of claim 33 further including overriding the criteria if the medication does not meet the eligibility criteria.

36. The method of claim 35 where overriding the eligibility criteria includes requesting an override from the third party.

37. The method of claim 35 where overriding the eligibility criteria is performed in accordance with an agreement between the practitioner and the third party permitting the practitioner to modify at least some of the criteria in specified situations.

38. The method of claim 30 where modifying the care plan includes modifying a medication by the practitioner.

39. The method of claim 38 where modifying a medication includes modifying at least one of a dosage, a duration, a frequency, or a delivery route of the medication.

40. The method of claim 38 further comprising changing one of the prescription medications by the practitioner directly in accordance with a collaborative practice agreement with a health-care provider who is competent to authorize prescription medications.

41. The method of claim 30 further including:
determining whether or not a certain indication represents a chronic condition;
assigning a medication associated with the certain indication to different pharmacies in response thereto.

42. The method of claim 41 where the medication is assigned to a mail-order pharmacy if the condition is chronic.

43. The method of claim 41 where the assigning is performed under an agreement with a third-party provider allowing the practitioner to assign the medication.

44. The method of claim 30 where generating the care plan includes receiving a prescription for a medication from a health-care provider.

45. A method practiced by a registered pharmacist, comprising:
including a medication in a care plan for a patient;
determining that the medication is not eligible for reimbursement under criteria of a third-party provider for the patient;
overriding the criteria so as to allow reimbursement for the medication in accordance with an agreement operative between the registered pharmacist and the third-party provider.

46. The method of claim 45 where the medication is a prescription medication.

47. The method of claim 45 where overriding includes requesting an approval from the third-party provider for the specific situation.

48. The method of claim 45 where overriding may be performed directly by the pharmacist without prior authorization from the third-party provider.

49. The method of claim 48 further comprising notifying the third-party provider that the medication has been allowed for the specific situation.

50. The method of claim 48 where the agreement allows modifying at least one of a dosage, a duration, a frequency, or a delivery route for the medication.

51. The method of claim 48 where the agreement allows overriding criteria relating to number or timing of refills.

52. The method of claim 48 where the agreement allows overriding criteria relating to generic medications.

53. The method of claim 48 where the agreement allows overriding criteria relating to where the medication may be obtained.

54. The method of claim 45 further comprising storing terms of the agreement in a searchable database containing agreement terms between the pharmacist and other third-party providers.

55. A method practiced by a registered pharmacist, comprising:
including a prescription medication in a care plan for a patient who receives reimbursement under a reimbursement plan from a third-party provider;
selecting a source for the medication in accordance with an agreement between the pharmacist and the third-party provider.

56. The method of claim 55 where the agreement specifies that the pharmacist may select between local dispensing pharmacists and mail-order dispensing pharmacists.

57. The method of claim 55 where the pharmacist is allowed to select a source not covered under the patient's reimbursement plan.

58. The method of claim 57 where the pharmacist is allowed to select the source without prior permission from the third-party provider.

59. The method of claim 55 further including notifying the third-party provider of the selected source.

60. The method of claim 55 further comprising storing terms of the agreement in a searchable database containing agreement terms between the pharmacist and other third-party providers.
